(19) United States
(12) Patent Application Publication
(10) Pub. No.: US 2011/0174832 A1
(43) Pub. Date: Jul. 21, 2011

(54) METHOD AND APPARATUS FOR A DISPOSABLE CUP

(76) Inventor: Richard M. Dickson, Kirkland, WA (US)

(21) Appl. No.: 13/009,448

(22) Filed: Jan. 19, 2011

Related U.S. Application Data
(60) Provisional application No. 61/336,388, filed on Jan. 20, 2010.

(51) Int. Cl. B65D 5/46; B65D 90/12; B31B 1/14

(52) U.S. Cl. 220/752; 220/737; 493/63

(57) ABSTRACT

Cups, a cup holding system, and methods for assembling a cup are disclosed. In a described example, a cup includes a handle, a perforated edge having a plurality of perforations, and a folded edge configured to extend from an end of the handle to an end of the perforated edge. A tear tab is attached to the perforated edge and configured to be separated from the perforated edge. At least one crease extends from the end of the handle to the perforated edge. In another described example, a method includes applying adhesive to a foldable material, folding the foldable material over an axis, and generating at least one crease in the foldable material. An edge of the foldable material is perforated.

### CROSS-REFERENCE TO RELATED APPLICATION(S)

This application claims priority to provisional U.S. Patent Application Ser. No. 61/336,388, filed Jan. 20, 2010, which application is incorporated herein by reference, in its entirety, for any purpose.

### TECHNICAL FIELD

This invention relates generally to cups, and more specifically, to methods and apparatus for sealed and expandable disposable cups.

### BACKGROUND OF THE INVENTION

Cups may be used by individuals for a multitude of reasons, such as carrying liquid, consuming a beverage, transporting a pill or other medicine for later use, or measuring ingredients. However, there may frequently be occasions where a cup is required, but not normally available. For example, water may be available in a public restroom, but with no containers available to facilitate consuming the water. Alternatively, individuals may want to pack cups when camping or hiking, but may not desire using storage space to store a bulky, standard container.

Additionally, in circumstances where cups are available, there is no guarantee that the cups are sanitary. Cups, particularly in public environments, may become contaminated or have been previously used by others. Without any clear indication of whether a cup is sanitary, individuals may have no way of determining which cups are safe for use.

Therefore, a need exists for a disposable cup that is sanitary and easy to transport.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures.

FIG. 1 is a perspective view of a cup in an open state according to an embodiment of the invention.

FIG. 2A is a profile view of the cup in an unopened state according to an embodiment of the invention.

FIG. 2B is a profile view of the cup in an unopened state according to an embodiment of the invention.

FIG. 3 is a profile view of the cup in an unassembled state according to an embodiment of the invention.

FIG. 4 is a profile view of the cup in an unopened state having rounded corners according to an embodiment of the invention.

FIG. 5 is a perspective view of the cup in an open state having rounded corners according to an embodiment of the invention.

FIG. 6 is a perspective view of the cup with a sleeve according to an embodiment of the invention.

FIG. 7 is a perspective view of the cup and the sleeve mounted in a receptacle base according to an embodiment of the invention.

FIG. 8 is a perspective view of the cup and the sleeve mounted on a pronged base according to an embodiment of the invention.

FIG. 9 is a perspective view of a cup dispenser according to an embodiment of the invention.

FIGS. 10A is profile view of a cup having hollow protrusions according to an embodiment of the invention. FIG. 10B is a top view of a cup having hollow protrusions according to an embodiment of the invention.

### DETAILED DESCRIPTION

Embodiments of the invention are directed toward a sealed, disposable cup having a perforated edge for opening. Certain details are set forth below to provide a sufficient understanding of various embodiments of the invention. However, it will be clear to one skilled in the art that the invention may be practiced without these particular details.

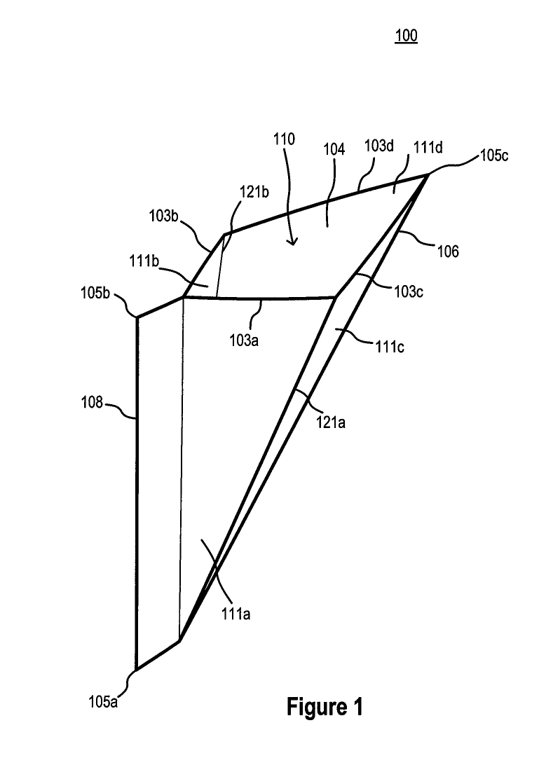

FIG. 1 illustrates a perspective view of the cup 100 in an open state. The cup 100 may have edges 103a-d that define opening 104 and a corner 105c, and may also include a folded edge 106 and a handle 108. Handle 108 and folded edge 106 may span from corner 105a to corners 105b, 105c respectively.

As will be explained in more detail below, handle 108 may comprise two edges of a foldable material that may be sealed, for example, with glue or other adhesives now known by those skilled in the art, or later developed. In one embodiment, handle 108 is sealed water-tight from corner 105b to corner 105a such that a recess 110 inside of the cup 100 is water-tight except for opening 104. In another embodiment, handle 108 may be sealed only partially between corners 105a, 105b. Thus, in various embodiments, the cup 100 may have many uses, for example, as a drinking cup, scoop, dispenser, or medicinal packet.

Cup 100 may further include sides 111a and 111b that extend from the handle 108 to creases 121a and 121b. Cup 100 may also have sides 111c and 111d that extend from folded edge 106 to creases 121a and 121b. Creases 121a, 121b and sides 111a-d may span from corner 105a to opening 104 to substantially define the shape of cup 100. In other embodiments, cup 100 may have any number of creases and sides.

Cup 100 may comprise a foldable material such as paper, but those having skill in the art will recognize that cup 100 may comprise any shapeable material, including cloth, aluminum-lined paper, metallic-lined paper, waxed paper, waxed light-cardboard, biodegradable materials, malleable plastics, synthetic or plastic paper, light malleable metal foils, or combinations thereof, or other malleable metals, and further, may be of any thickness. In another embodiment, cup 100 may comprise two independent sheets of foldable material, whereby folded edge 106 may be replaced by an additional handle 108 (not shown). In yet another embodiment, cup 100 may comprise a material having rough texture or a plurality of protuberances that may improve grip of cup 100. Additionally, cup 100 may comprise biodegradable material. The interior of cup 100, defined by recess 110 may be configured in different embodiments to have different shapes, for example, have an interior shaped such as a tetrahedron, cone, or square pyramid.

The interior of cup 100, defined by recess 110, may be sanitary in that once formed, the interior of cup 100 is sealed until use by tearing away the tear tab 201 at the perforated edges 103a-d opening the cup 100 into its open state.

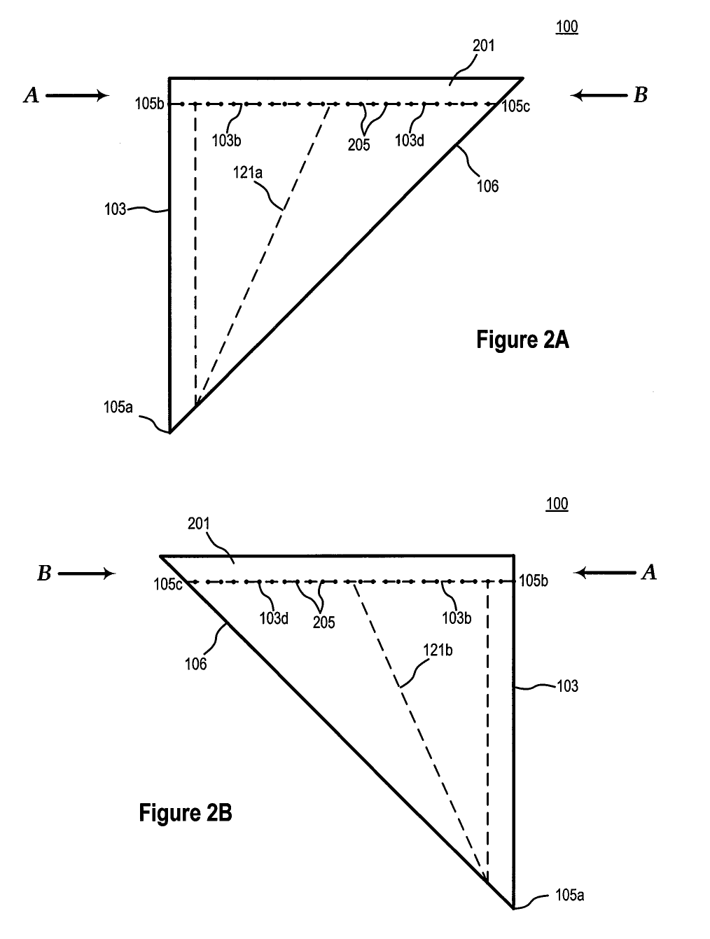

Profile views of the cup 100 in an unopened state are illustrated in FIGS. 2A and 2B. Cup 100 includes a tear tab 201 that may be attached to perforated edges 103a-d, thereby holding cup 100 in an unopened state. A line of perforations 205 may extend from the corner 105b to corner 105c and define the junction between perforated edges 103a-d and tear tab 201. Creases 121a, 121b are also included in cup 100, and as will be explained in more detail below, determine the shape of recess 110 when cup 100 is opened. Creases 121a, 121b may extend from corner 105a to the junctions of perforated edges 103a, 103b and 103c, 103d, respectively. In other embodiments, creases 121a,b may extend to any point on perforated edges 103a-d between corners 105b and 105c.

In operation, cup 100 may be changed from an unopened state to an open state by removing tear tab 201 and forming recess 110 (FIG. 1). In one embodiment, tear tab 201 may be removed from cup 100 by fully removing tear tab 201 from the line of perforations 205. Inward pressure may be applied to handle 108 and to folded edge 106 (illustrated in FIGS. 2A and 2B as pressure A and B) to cause creases 121a, 121b to be pushed outward in opposite directions perpendicular to the applied force. This in turn may expand opening 104 and shape recess 110 (FIG. 1). Additionally, in an embodiment, as handle 108 and corner 105c are pushed together, this may cause corner 105c to shift upward, forming a spout in cup 100.

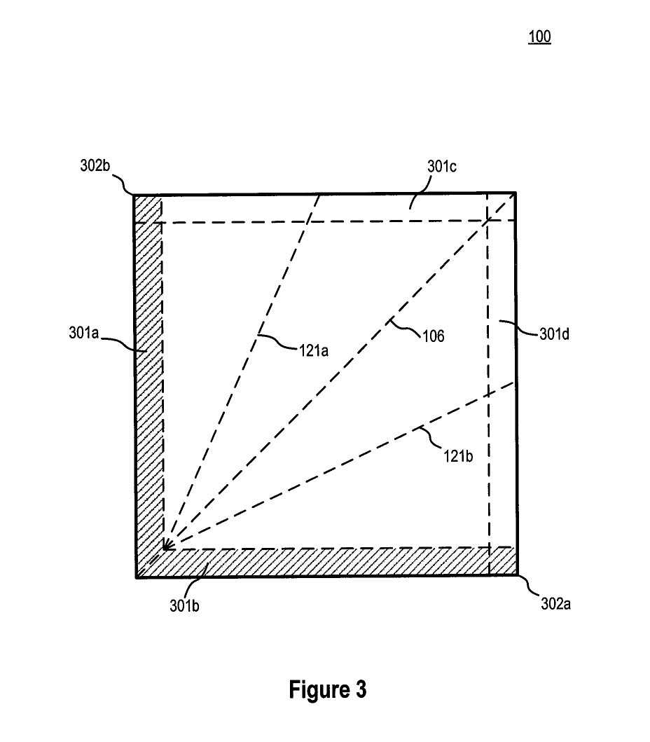

An embodiment of the present invention is illustrated in FIG. 3 where cup 100 is shown in an unassembled state. In the present embodiment, cup 100 is formed from a square piece of shapeable material, for example, paper, cloth, plastic, or metal, as previously disclosed. In other embodiments, cup 100 may be formed from other shapes of shapeable material, for example, a rectangle, circle, triangle, or other shape used by those skilled in the art.

Adhesive may be applied to interior edges 301a-301d and cup 100 may be folded over folded edge 106, aligning handle corner 302a with handle corner 302b to form corner 105b (FIGS. 2A and 2B). Interior edges 301a, 301b and 301c, 301d may also be aligned, respectively, thereby forming both handle 108 along the interior edges 301a, 301b and a punch side (not shown) along interior edges 301c, 301d with the applied adhesive. In the embodiment illustrated in FIG. 3, the resulting shape from folding along the folded edge 106 is a triangle. Subsequently, cup 100 may be folded, at least partially, to create creases 121a, 121b that span from proximate corner 105a to tear tab 201. Finally, punch side 304 may be perforated at a point below the edge of any adhesive applied to interior edges 301c, 301d, creating the line of perforations 205 (FIGS. 2A and 2B). Thus, the portion of cup 100 along interior edges 301c, 301d and the line of perforations 205 may become tear tab 201 (FIGS. 2A and 2B). In another embodiment, adhesive may be applied to interior edges 301a-301d after cup 100 is folded over folded edge 106. In other embodiments, interior edges 301a-301d may be sealed to form handle 108 and punch side using any method of sealing or fastening known by those skilled in the art. For example, stitching, taping, or lamination may be used. Additionally, creases 121a, 121b may be formed prior to folding cup 100 over folding edge 106.

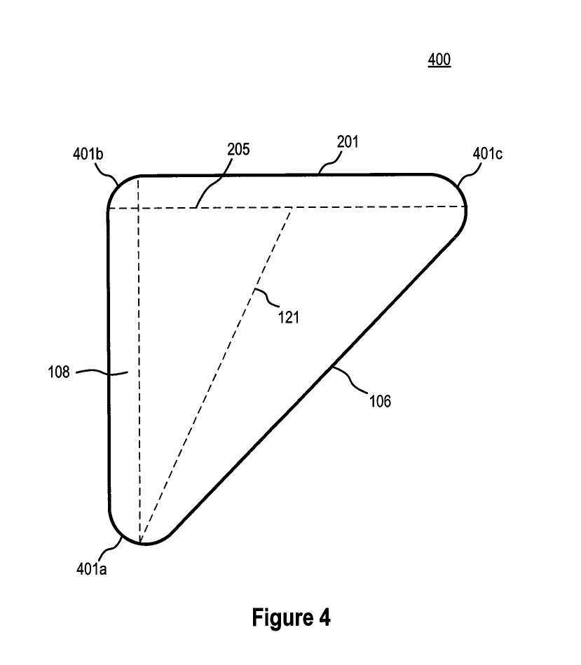

FIG. 4 illustrates an embodiment of the present invention in an unopened state. Cup 400 may have a plurality of corners 401a-401c, some of which may be rounded to help reduce prodding otherwise resulting from pointed corners. When used as a drinking cup, for example, cup 400 may be less likely to poke the eye or scratch the skin of a user, or to be caught at the corners 401a-401c. In other embodiments, only one or more of corners 401a-401c of cup 400 may be rounded. Corners 401a-401c may be shaped to have other shapes known by those skilled in the art. Corners 401a-401c, for example, may have a shape defined by a perfect partial circle, piecewise-continuous line segments, or an arc. In some embodiments, the curvatures of the corners 401a-401c are the same. In other embodiments, the curvatures of at least two of the corners are different. The cup 400, as with cup 100 illustrated in FIGS. 2A and 2B, includes a folded edge 106 and a handle 108. A tear tab 201 is formed along the edge between corners 401b and 401c by line of perforations 205. A crease 121 is formed from proximate the corner 401a to the edge between corners 401b and 401c, which may facilitate formation of the cup 400 for use.

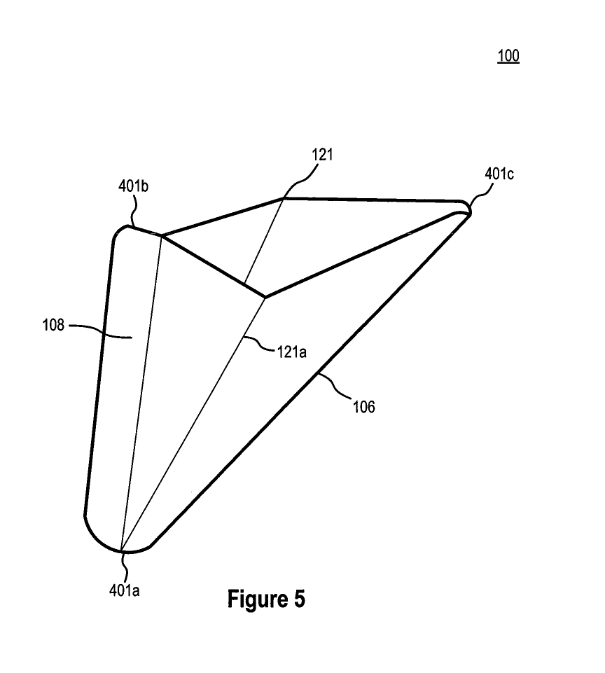

FIG. 5 illustrates cup 400 in an open state. The cup 400 may be opened similarly to the process previously described with reference to the cup 100. After tear tab 201 has been removed and cup 400 opened, corners 401b, 401c may have reduced curvature due to the missing curvature of tear tab 201, as shown. That is, the curvatures of corners 401b and 401c intersect the edge between the corners and line of perforations 205 of unopened cup 400 such that the width of the curvature is greater than the width of the tear tab 201. In some embodiments, however, corners 401b, 401c may not lose curvature from the removal of tear tab 201.

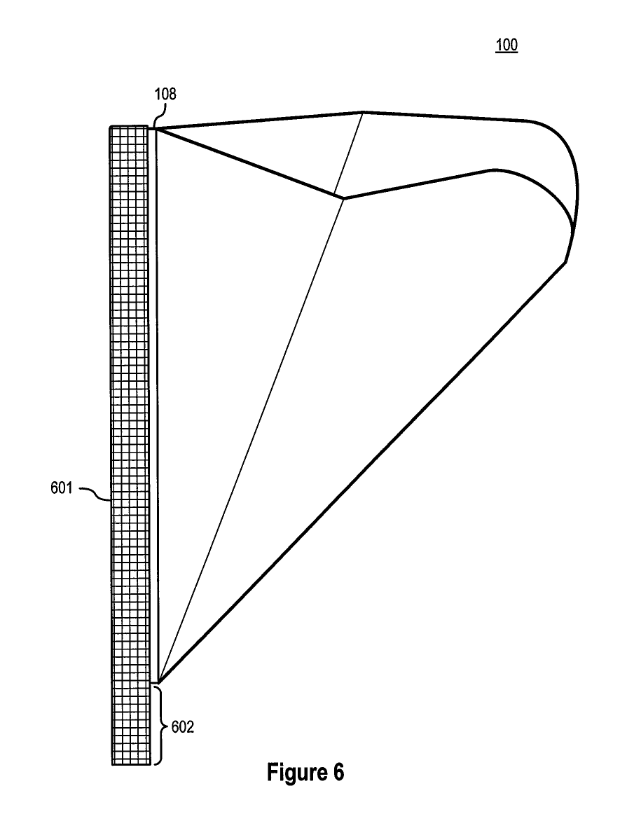

Another embodiment of the invention is shown in FIG. 6. A sleeve 601 may be placed over at least a portion of handle 108 of cup 100, for example, when in an open state. The sleeve 601 may be substantially rigid. This may provide additional handle rigidity for cup 100 as well as facilitate easier handling of cup 100 by a user. Sleeve 601 may be “U” shaped and may slide over both sides of handle 108. In some embodiments, sleeve 601 may span the entire length of handle 108, or further, or may span only a portion of handle 108. For example, as shown in FIG. 6, portion 602 of sleeve 601 extends beyond the length of handle 108. Additionally, sleeve 601 may be formed from various materials, for example, plastic, metal, wood, rubber, glass, paper, or other materials.

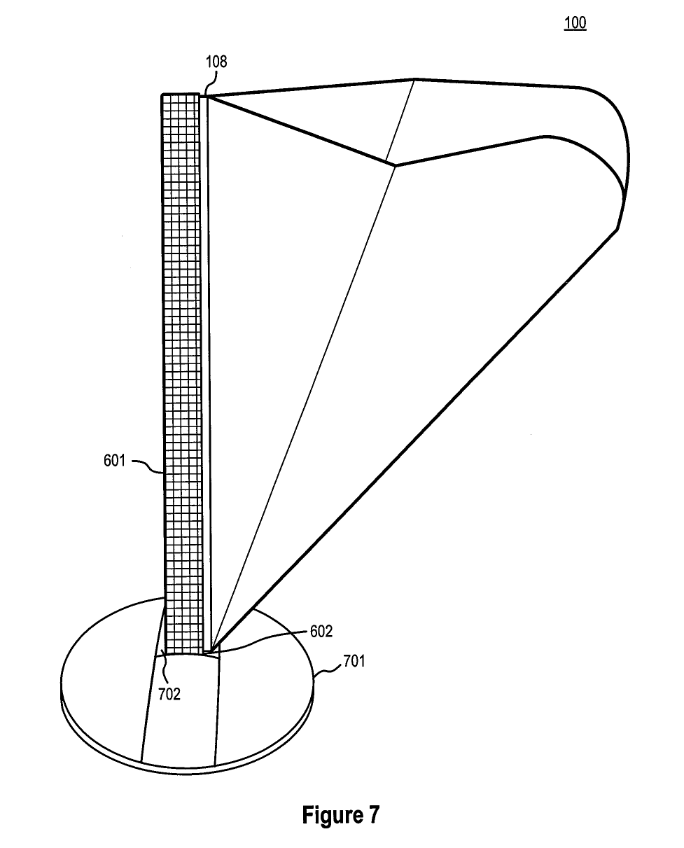

FIG. 7 illustrates an embodiment of the invention using a base 701. Base 701 may include a recess 702 for receiving sleeve 601. After cup 100 has been combined with sleeve 601 (FIG. 6), sleeve 601 may be placed in the recess 702 of base 701 to allow cup 100 to stand upright without being hand held. Sleeve 601 may be secured in recess 702 by, for example, a hole shaped to securely hold sleeve 601, a clamp, or a spring loaded slide.

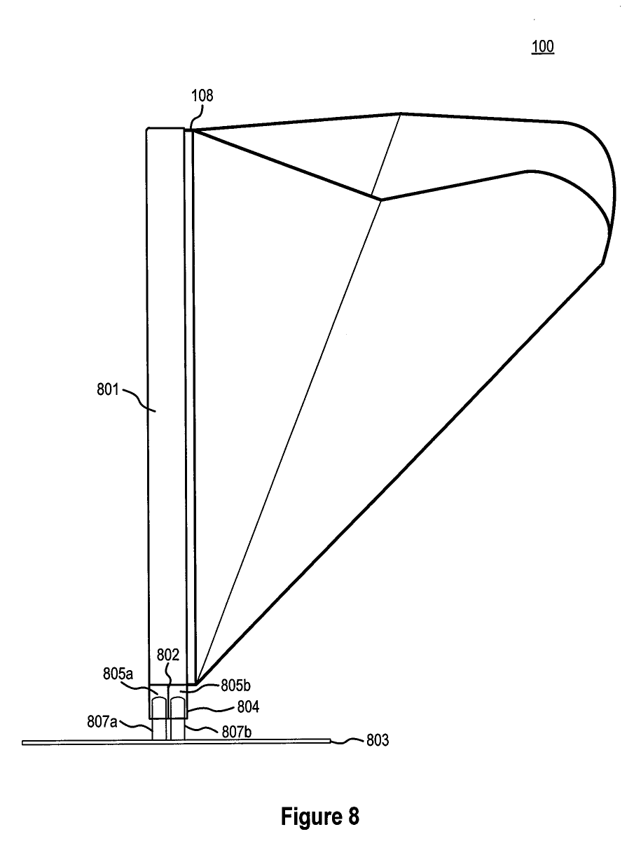

FIG. 8 shows another embodiment of the present invention. Sleeve 801 may include an open-ended mount 804 and a partition 802 between two recesses 805a, 805b in mount 804. Base 803 may include prongs 807a, 807b that are configured to be inserted into recesses 805a, 805b respectively. After sleeve 801 is attached to cup 100, sleeve 801 may be fixed on mount 804 by inserting prongs 807a, 807b into recesses 805a, 805b. This may allow cup 100 to stand upright without additional support. It may be appreciated by those skilled in the art that base 803 may have any number of prongs and that mount 804 may have any number of recesses. Additionally, cup 100 may also be placed into sleeve 801 after sleeve 801 has been fixed to base 803.

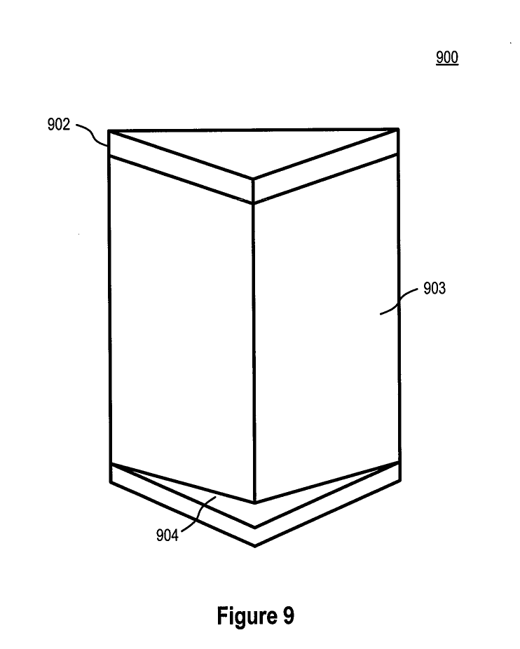

Another embodiment of the invention is illustrated in FIG. 9. A dispenser 900 may have a lid 902, a body 903, and a slot 904. Dispenser 900 may contain a plurality of cups 100 in an unopened state and dispense a cup 100 out of slot 904. Each time a cup 100 may be removed from slot 904, a stack of cups 100 inside of dispenser 900 may lower due to gravity, readying another cup 100 for removal. In some embodiments, slot 904 may be an angled base of dispenser 900 or a slit near the bottom of the frame of dispenser 900. In another embodiment of dispenser 900, slot 904 may be on the bottom of dispenser 900 (not shown), allowing for cups 100 to be pulled out of dispenser 900 in a downward direction.

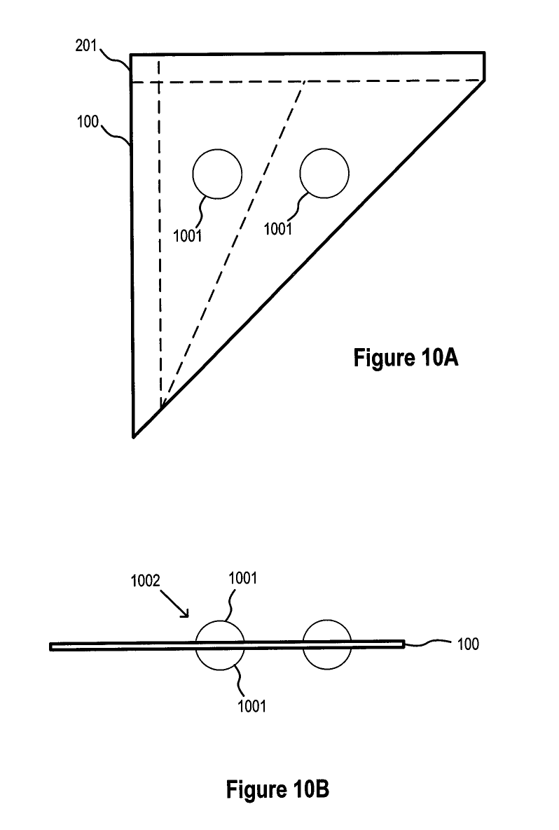

FIG. 10A illustrates an embodiment of cup 100 having pockets 1001. Sides 111 may each contain a hollow pocket 1001 that forms a pouch. Objects, for example, medicine, may be packaged in pockets 1001, and pushed through a side into the recess of an open cup so that the object may be accessed. In some embodiments, the medicine packaged in pockets 1001 is aspirin.

As shown in FIG. 10B, each side of cup 100 may have a corresponding pocket 1001 such that a pocket 1001 on opposite sides of cup 100 are aligned to create a cavity 1002 in an unopened cup 100. Thus, contents contained in a cavity 1002 may fall loosely into recess 110 (FIG. 1) upon removing tear tab 201 and opening cup 100. For example, if a pill 1003 (not shown) were contained in pocket 1002, and tear tab 201 were removed from cup 100, upon opening cup 100, pockets 1001 would separate and open cavity 1002, making pill 1003 accessible. Pill 1003 could then be removed from recess 110, cup 100 filled with water, and pill 1003 ingested with the water in cup 100. In other embodiments, cup 100 may have any number of pockets 1001, water may already be included in cup 100 with pill 1003, or powder may be packaged in cavity 1002. Additionally, pockets 1001 may be pressure formed indentations or may be separate plastic inserts in the sides of cup 100.

From the foregoing it will be appreciated that, although specific embodiments of the invention have been described herein for purposes of illustration, various modifications may be made without deviating from the spirit and scope of the invention. Accordingly, the invention is not limited except as by the amended claims.

What is claimed is:

1. A cup, comprising:
a handle;
a perforated edge having a plurality of perforations;
a folded edge configured to extend from an end of the handle to an end of the perforated edge;
a tear tab attached to the perforated edge and configured to be separated from the perforated edge; and
at least one crease extending from proximate the end of the handle to the perforated edge.

2. The cup of claim 1, wherein the cup comprises a water-resistant material.

3. The cup of claim 2, wherein the water-resistant material comprises an aluminum-lined paper, metallic-lined paper, waxed paper, waxed light-cardboard, biodegradable materials, malleable plastics, synthetic or plastic paper, light malleable metal foils, or combinations thereof.

4. The cup of claim 1, wherein the cup has a substantially triangular shape.

5. The cup of claim 1, further comprising:
a corner at the junction of the folded edge and the perforated edge, the corner configured to be round.

6. The cup of claim 1, wherein the handle is watertight.

7. A cup holding system, comprising:
a cup, comprising:
a handle;
a perforated edge having a plurality of perforations;
a folded edge configured to extend from an end of the handle to an end of the perforated edge;
a tear tab attached to the perforated edge; and
at least one crease extending from the end of the handle to the perforated edge;
a sleeve configured to receive the handle of the cup; and
a cup base configured to engage the sleeve to hold the cup in an upright position.

8. The cup holding system of claim 7, wherein the cup base comprises a cup base having a recess configured to receive the sleeve.

9. The cup holding system of claim 7, wherein the cup base comprises a cup base having at least one prong configured to be inserted into the sleeve.

10. The cup holding system of claim 7, wherein the sleeve is longer than the handle.

11. The cup holding system of claim 7, wherein the sleeve is formed from a plastic material.

12. The cup holding system of claim 7, wherein the cup base has a recess, the sleeve further configured to mate with the recess of the base.

13. A method for assembling a cup, comprising:
applying adhesive to a foldable material;
folding the foldable material over an axis;
generating at least one crease in the foldable; and
perforating an edge of the foldable material.

14. The method of claim 13, further comprising:
cutting at least one corner into a rounded shape.

15. The method of claim 13, wherein the foldable material is rectangular in shape.

16. The method of claim 14, wherein said applying adhesive comprises:
applying adhesive to a first edge of the foldable material;
applying adhesive to a second edge of the foldable material adjacent to the first edge.

17. The method of claim 13, wherein said perforating an edge comprises:
perforating an edge of the foldable material with a line of perforations, the line of perforations intersecting the at least one crease.

18. A cup, comprising:
a handle;
a folded edge;
a perforated edge configured to form a recess responsive to the handle receiving a first force and the folded side receiving a second force, the second force substantially opposing the first force; and
at least one crease configured to intersect the perforated edge,
wherein the recess is formed based, at least in part, on a location of the intersection between the at least one crease and the perforated edge.

19. The cup of claim 18, wherein the recess is watertight.

20. The cup of claim 18, wherein the cup is formed from paper.

21. The cup of claim 18, wherein the location of the intersection is substantially at the midpoint of the perforated edge.

22. The cup of claim 18, further comprising:
a pocket configured to form a pouch.
